(19) United States
(12) Patent Application Publication
(10) Pub. No.: US 2026/0167822 A1
(43) Pub. Date: Jun. 18, 2026

(54) POLYAMIDE MOULDING COMPOUND AND MULTI-LAYER STRUCTURE

(71) Applicant: EMS-CHEMIE AG, Domat/Ems (CH)

(72) Inventor: Etienne AEPLI, Domat/Ems (CH)

(73) Assignee: EMS-CHEMIE AG, Domat/Ems (CH)

(21) Appl. No.: 19/413,164

(22) Filed: Dec. 9, 2025

(30) Foreign Application Priority Data
Dec. 13, 2024 (EP) 24219907

(51) Int. Cl. C08L 77/06; H01B 3/30; H01B 13/14

(52) U.S. Cl. CPC C08L 77/06; H01B 3/305; C08L 2203/202; C08L 2205/025; C08L 2205/03; H01B 13/14

(57) ABSTRACT

Disclosed is a polyamide moulding compound containing a mixture of at least one semi-crystalline polyamide, at least one amorphous polyamide based on aliphatic diamines, at least one vinylaromatic block copolymer and/or a polyolefin, and optionally additives in specific mixing ratios. The polyamide moulding compound is distinguished by high chemical and thermal resistance, making it particularly suitable as a sheath for metal structures such as electrical conductors. Also disclosed is a layer structure with at least one metal element and at least one polyamide layer formed from the polyamide moulding compound. Further disclosed is a method for producing a layer structure and to the use of a polyamide moulding compound for producing an electrical conductor insulated with a polyamide layer.

### CROSS-REFERENCE TO A RELATED APPLICATION

This patent application claims the benefit of European Patent Application No. 24219907.3, filed Dec. 13, 2024, which is incorporated by reference in its entirety for all purposes.

### BACKGROUND OF THE INVENTION

Metal wires made of copper or aluminium, for example, are widely used as conductors, e.g., for transmitting electricity or for windings, in cars, electric motors, three-phase motors and transformers, etc. The wires are provided with an electrical insulation coating on their surface to protect and insulate the conductors, e.g., individual wire windings from each other, in order to prevent short circuits. To protect them from damage and for insulation purposes, metallic conductors are often coated with plastic layers or are varnished. The insulation layers should have high scratch and adhesive strength as well as high resistance to abrasion, but must also be sufficiently flexible, i.e., the coating should not tear when the wires are bent and stretched during further processing. Such a coating should also remain stable when in contact with water, salt solutions and chemicals, especially fuels and oils, particularly in the automotive sector.

US-A-2004/0028921 relates to coated metal surfaces, in particular for metal pipes in the automotive sector for, e.g., brake fluids, wherein the metal is first provided with optional primer or adhesion promoter layers before a layer of a mixture of polyamide and carboxylic acid anhydride-modified polyolefins is applied. The metal may be aluminium, and the polyamide may be semi-crystalline polyamide such as PA11 and PA12, or constituted by other aliphatic polyamides.

EP-A-1 351 000 describes steel fuel lines, optionally coated with aluminium, which are coated with a layer of PA12 by means of extrusion. US-A-2001/0023537 relates to extrusion-coated metal articles in which the metal is first coated with an organic silane compound and then with a polyamide. A wide range of common polyamides is mentioned as polyamides without any particular preference.

An example of metal coating with polyamide powders using the vortex sintering process is described in DE-T-697 04 007 and DE-T-695 26 745. After coating the metal, the polyamide powder is melted by heat, creating a closed plastic coating on the metal. Steel plates are coated with PA11, with the optional use of fillers.

DE-A-10 2007 054 004 describes metal composites formed of a metal base profile and one or two partially overlapping plastic profiles. Specifically, polyamides PA6 and PA66 are mentioned for the plastic element A and polyamide PA12 for the plastic element B.

U.S. Pat. No. 6,291,024 describes coated metal surfaces, wherein the structure consists sequentially of a metal, a layer of thermoplastic polyurethane and a layer of a different thermoplastic. Adhesion promoter layers may be used optionally. Such a structure is used in pipes, electrical cables and telecommunications cables. Polyamides and polyolefins are mentioned as thermoplastics.

U.S. Pat. No. 6,235,361 is very similar. It describes a structure in which the metal surface is first coated with a layer of epoxy resin, followed by a polypropylene-based adhesion promoter layer and then a thermoplastic layer. Thermoplastic may be polyamide, among other things.

EP-A-2 746 342 discloses the use of a polyamide moulding compound for the production of a colourfast article in which the colouring tendency (CT) is at least 2. The compound contains 30-100 wt. % of a polyamide or a polyamide mixture consisting of 50-100 wt. % % of at least one amorphous or microcrystalline polyamide with a glass transition temperature of at least 100° C., based on a cycloaliphatic diamine and aromatic or aliphatic dicarboxylic acids with at least 6 carbon atoms.

DE 10 2007 003327 discloses a film containing the following layers: I. a layer based on a polyamide of which the monomer units contain an average of at least 8 C atoms, II. an immediately adjacent layer of a moulding compound containing a polyamide as under I. and a copolymer having functional groups. The film is used to produce a composite with a substrate containing PA6, PA66, PA6/66 or PPA, resulting in strong adhesion.

WO-A-2014170148 describes the use of thermoplastic moulding compounds containing a thermoplastic polyamide, red phosphorus, a dialkylphosphinic acid salt and an ethylene copolymer as an impact modifier for the production of flame-retardant, glow-wire-resistant moulded articles.

EP 4 253 479 A1 relates to a polyamide moulding compound with high fracture energy and moulded parts formed therefrom, which are particularly suitable for visible parts in automotive components or electronic devices. In addition to excellent fracture energy, the polyamide moulding compound also has a piano lacquer appearance and high abrasion resistance. Its use as cable sheathing is not mentioned.

EP 3 031 862 A1 relates to multi-layer structures with at least one metal layer and at least one polyamide layer, in particular for use as insulated electrical conductors, as well as the use of polyamides for coating metals. The proposed polyamide layer consists of a mixture of cycloaliphatic polyamides and polyolefins, to which small amounts of open-chain aliphatic polyamides may be added optionally. Cable sheaths, as described in the examples, may only be used up to a maximum of 130° C., because above this temperature the sheath softens too much. Furthermore, such sheaths are not resistant to ethanol-containing liquids.

A disadvantage of the multi-layer structures known from the prior art, however, is that they still have insufficient chemical and heat resistance to be used in chemically and thermally demanding environments in particular.

### SUMMARY OF THE INVENTION

One of the objects of the present invention is therefore to provide an improved polyamide moulding compound from which a cable sheath may be produced for a metal conductor in the form of a continuous profile and a polyamide layer arranged circumferentially and preferably without an adhesive layer on the metal conductor, manufactured from the polyamide moulding compound according to the invention. The cable sheath should in particular have high chemical, thermal and mechanical resistance, especially to engine oil, brake fluid, automatic transmission oil, coolant, AdBlue, petrol, diesel, ethanol and acetone. Furthermore, the cable sheath should have sufficient mechanical stability up to 180° C. and the specific volume resistivity should be at least 1.0E+10 ohm*m in the temperature range from 20 to 180° C. Furthermore, the specific volume resistivity should still be at least 1.0E+10 ohm*m even after 3000 hours of storage at 180° C.

This object is achieved with regard to a polyamide moulding compound with the features defined in the claims, with a layer structure defined in the claims, a method for producing a layer structure defined in the claims, and the use of a polyamide moulding compound as described herein. The dependent claims represent advantageous refinements.

### DETAILED DESCRIPTION OF THE INVENTION

In a first aspect the present invention therefore relates to a polyamide moulding compound, wherein the polyamide moulding compound comprises or consists of the following components (A), (B) and (C), and optionally (D):
(A) 40-85 wt. % of at least one semi-crystalline polyamide selected from the group of the homopolyamides PA46, PA66, PA610, PA612, PA1010, PA1012 and the copolyamides PA 66/6T and PA 66/6I/6T;
(B) 8-35 wt. % of at least one amorphous polyamide based on aliphatic diamines with 6 to 24 carbon atoms and aliphatic and/or aromatic dicarboxylic acids with 6 to 36 C atoms, and optionally lactams and/or α,ω aminocarboxylic acids;
(C) 7-20 wt. % of at least one polyolefin (C1) based on C2-C12 alkenes and/or at least one block copolymer (C2) based on vinylaromatic monomers and C2-C5 alkenes, or a mixture thereof, wherein the stated alkenes may be present in branched or unbranched form, and
wherein the vinylaromatic block copolymers (C2) and/or the polyolefins (C1) contain at least one additional monomer (M) selected from the group consisting of maleic anhydride, itaconic anhydride, glycidyl acrylate, glycidyl methacrylate, acrylic acid, methacrylic acid, vinyl acetate, C1-C12 alkyl acrylates, preferably ethyl acrylate or butyl acrylate, C1-C12 alkyl methacrylates, or a mixture of such monomers, and
wherein these additional monomers (M) may be arranged in the polymer chain or grafted onto the polymer chain;
(D) 0-5 wt. % additives, differing from components (A) to (C),
with the provision that the sum of components (A)-(D) is 100 wt. %.

Surprisingly, it was found that the above-mentioned polyamide moulding compound achieves the object stated at the outset and exhibits excellent resistance to chemicals and high temperature resistance.

The terms “containing” and “comprising” in the present claims and in the description mean that further components are not excluded. Within the context of the present invention, the term “consisting of” is to be understood as the preferred embodiment of the terms “containing” or “comprising”. When it is defined that a group “contains” a certain number of components, or “comprises” the same, this is to be understood such that a group is disclosed which preferably “consists” of these components. In the event that the polyamide moulding compound comprises the aforementioned components, components (A) to (D) add up to 100 wt. %, but the polyamide moulding compound then also contains other components that differ from (A) to (D).

For the purposes of the present invention, the term “polyamide” (abbreviation PA) is understood to be a generic term which includes homopolyamides and copolyamides. The chosen notations and abbreviations for polyamides and their monomers correspond to those specified in ISO standard 16396-1 (2015 (D)). The abbreviations used therein are used in the following as synonyms for the IUPAC names of the monomers, in particular the following abbreviations for monomers are used: BAC for 5 bis(aminomethyl)cyclohexane, wherein this includes 1,3-bis(aminomethyl)cyclohexane (1,3-BAC) and 1,4-bis(aminomethyl)cyclohexane (1,4-BAC), MACM for bis(4-amino-3-methyl-cyclohexyl) methane (also known as 3,3′-dimethyl-4,4′-diaminodicyclohexylmethane, CAS No. 6864-37-5), PACM for bis(4-amino-cyclohexyl) methane (also known as 4,4′-diaminodicyclohexylmethane, CAS no. 1761-71-3), TMDC for bis(4-amino-3,5-10 dimethylcyclohexyl) methane (also known as 3,31,5,5′-tetramethyl-4,4′-diaminodicyclohexylmethane, CAS No. 65962-45-0), T for terephthalic acid (CAS No. 100-21-0), and I for isophthalic acid (CAS No. 121-95-5).

Compared to semi-crystalline polyamides, amorphous polyamides have no or only a very low, barely detectable heat of fusion. Amorphous polyamides, in dynamic differential calorimetry (DSC) according to ISO 11357 (2013) at a heating rate of 20 K/min, preferably exhibit a heat of fusion of a maximum of 5 J/g, particularly preferably of a maximum of 3 J/g, very particularly preferably of 0 to 1 J/g. Amorphous polyamides have no melting point due to their amorphous nature.

Within the meaning of the invention, semi-crystalline polyamides are polyamides which, in dynamic differential calorimetry (DSC) according to ISO 11357 (2013) at a heating rate of 20 K/min, preferably have a heat of fusion of more than 5 J/g, particularly preferably of at least 25 J/g, very particularly preferably of at least 30 J/g.

### Component (A)

The polyamide of component (A) in this case is a specific semi-crystalline polyamide selected from the group of homopolyamides PA46, PA66, PA610, PA612, PA1010, PA1012 and copolyamides PA 66/6T and PA 66/6I/6T, and mixtures thereof.

In the case of the copolyamides, the proportion of 6T repeating units is preferably 20 to 50 mol % and particularly preferably 25 to 45 mol %, in each case in relation to the sum of the mol % of all repeating units present in the copolyamide. The copolyamides (A) preferably have a melting point in the range from 220° C. to 280° C.

It is very particularly preferred that component (A) is a polyamide selected from PA66, PA610, PA612 or a mixture thereof.

### Component (B)

Preferably, component (B) consists of polyamides which have a glass transition temperature of at least 140° C. or, more preferably, 150° C., but preferably have a glass transition temperature of not more than 220° C. or not more than 200° C. Particularly preferred are polyamides of component (B) of which the glass transition temperature, determined at equilibrium humidity achieved after conditioning in accordance with ISO 1110 (storage of the samples for 14 days at 70° C. and 62% relative humidity), is at least 85° C., preferably at least 90° C. and particularly preferably at least 100° C. This is particularly advantageous because the use of such polyamides (B), of which the glass transition temperature does not fall below the specified temperature limits when in contact with water, may largely suppress the above-mentioned adverse electrochemical processes and thus maintain the adhesion between the metal element and the polyamide layer in the “electrical properties during water storage” test and minimize the degradation of the polyamide layer. The glass transition temperature is determined on the granulate in accordance with ISO standard 11357-11-2. Differential scanning calorimetry (DSC) is carried out here with a heating rate of 20° C./min. For the glass transition temperature (Tg), the temperature for the mid-range or inflection point is specified.

Component (B) is an amorphous polyamide based on aliphatic diamines with 6 to 24, preferably 6 to 17 carbon atoms and aliphatic and/or aromatic dicarboxylic acids with 6 to 36, preferably 8 to 12 carbon atoms. In this context, the term “aliphatic” in relation to the diamines or dicarboxylic acids means that cyclic or acyclic, saturated or unsaturated carbon structural units are present which do not comprise aromatic structural units. This means that aliphatic diamines comprise both cycloaliphatic diamines and open-chain diamines, and aliphatic dicarboxylic acids comprise both cycloaliphatic and open-chain aliphatic dicarboxylic acids.

Suitable cycloaliphatic diamines with respect to component (B) are, for example, bis-(4-amino-3-methyl-cyclohexyl)-methane (MACM), bis-(4-amino-cyclohexyl)-methane (PACM), bis-(4-amino-3-ethyl-cyclohexyl)-methane (EACM), bis-(4-amino-3,5-dimethyl-cyclohexyl)-methane (TMDC), 2,6-norbornanediamine or 2,6-bis-(aminomethyl)-norbornane or 1,3-diaminocyclohexane, 1,4-diaminocyclohexanediamine, isophorone diamine, 1,3-bis-(aminomethyl)cyclohexane (BAC), 1,4-bis-(aminomethyl)cyclohexane, 2,2-(4,4′-diaminodicyclohexyl) propane (PACP) or mixtures thereof. In particular, alkyl-substituted bis-(aminocyclohexyl) methane or bis-(aminocyclohexyl) propane are preferred. Linear and/or branched C1-C6, preferably C1-C4 alkyl groups are preferred as alkyl substituents, in particular methyl, ethyl, propyl, isopropyl or butyl groups, with methyl groups being particularly preferred. In a particularly preferred embodiment, bis-(4-amino-3-methyl-cyclohexyl) methane (MACM) and bis-(4-amino-3,5-dimethyl-cyclohexyl) methane (TMDC) are used as alkyl-substituted bis-(aminocyclohexyl) methane. The cycloaliphatic diamines BAC, PACM, MACM and TMDC are particularly preferred.

Open-chain (acyclic), branched or unbranched aliphatic diamines, such as 1,4-butanediamine, 1,5-pentanediamine, 2-methyl-1,5-pentanediamine, 2-butyl-2-ethyl-1,5-pentanediamine, 1,6-hexanediamine, 2,2,4-trimethylhexamethylenediamine, 2,4,4-trimethylhexamethylenediamine, 1,8-octanediamine, 2-methyl-1,8-octanediamine, 1,9-nonanediamine, 1,10-decanediamine, 1,11-undecanediamine, 1,12-dodecanediamine, 1,13-tridecanediamine and 1,14-tetradecanediamine, are also suitable.

Particularly preferred are unbranched open-chain aliphatic diamines with 6-12 carbon atoms, in particular 1,6-hexanediamine, 1,10-decanediamine and 1,12-dodecanediamine.

Dicarboxylic acids suitable for the polyamide (B) are: adipic acid, cork acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, octadecanedioic acid, C36 dimer fatty acid, isophthalic acid, terephthalic acid, naphthalenedicarboxylic acid, cis-and/or trans-cyclohexane-1,4-dicarboxylic acid and/or cis-and/or trans-cyclohexane-1,3-dicarboxylic acid (CHDA) and mixtures thereof. Aromatic dicarboxylic acids and straight-chain aliphatic dicarboxylic acids are preferred. The dicarboxylic acids terephthalic acid, isophthalic acid, sebacic acid and dodecanedioic acid are particularly preferred. A polyamide (B) of which the terephthalic acid content is at most 50 mol %, in relation to the sum of all dicarboxylic acids in component (B), is particularly preferred. It is particularly preferred if the proportion of terephthalic acid in component (B) is less than 45 mol % or if component (B) contains no terephthalic acid.

The polyamides (B) may also contain lactams or aminocarboxylic acids, in particular α,ω-amino acids or lactams with 6 to 12 carbon atoms, wherein the following selection is given by way of example: m-aminobenzoic acid, p-aminobenzoic acid caprolactam (CL), α,ω-aminocaproic acid, α,ω-aminoheptanoic acid, α,ω-aminooctanoic acid, α,ω-aminononanoic acid, α,ω-aminodecanoic acid, α,ω-aminoundecanoic acid (AUA), lauric lactam (LL) and α,ω-aminododecanoic acid (ADA). Caprolactam, α,ω-aminocaproic acid, lauric lactam, α,ω-aminoundecanoic acid and α,ω-aminododecanoic acid are particularly preferred. The proportion of lactams or amino acids in component (B) is 0 to 50 mol %, preferably 2 to 45 mol % and particularly preferably 3 to 35 mol %, in each case in relation to the sum of all monomers forming component (B).

Polyamide (B) is very particularly preferably selected from the group consisting of PA 6I/6T, PA MACM10, PA MACM12, PA MACM14, PA MACM10/1010, PA MACM12/1012, PA MACM14/1014, PA MACMI/12, PA MACMI/MACM12, PA MACMI/MACMT/MACM12, PA MACMI/MACMT/12, PA MACMI/MACMT/MACM12/MACM36, PA 6I/6T/MACMI/MACMT/PACMI/PACMT/12, PA 6I/6T/612/MACMI/MACMT/MACM12, and mixtures thereof.

### Component (C)

As component (C), the polyamide moulding compound according to the invention contains at least one polyolefin (C1) based on C2-C12 alkenes in branched or unbranched form and/or a vinylaromatic block copolymer (C2) based on a vinylaromatic monomer and C2-C5 alkenes, or a mixture thereof.

The term “alkenes” refers to aliphatic hydrocarbons constructed of carbon and hydrogen, which have at least one carbon-carbon double bond in the molecule at any position. This also includes polyenes such as dienes and trienes, but does not include aromatic hydrocarbon systems, i.e., ring systems with double bonds conjugated according to Hückel's rule.

In addition to the above-mentioned monomers, polymers (C1) and (C2) contain at least one additional monomer (M).

The additional monomer (M) may be selected from the following group: maleic anhydride, itaconic anhydride, glycidyl acrylate, glycidyl methacrylate, acrylic acid, methacrylic acid, vinyl acetate, C1-C12 alkyl acrylates, preferably ethyl acrylate or butyl acrylate, C1-C12 alkyl methacrylates or a mixture of such monomers. The additional monomer (M) may be incorporated either into the main chain of the polymers (C1) and (C2) or into their side chains, for example, via a graft reaction.

Component (C) may also contain additional monomer building blocks, again either in the main chain or incorporated via a graft reaction.

In particular, in component (C1), the proportion of C2-C12 alkenes is in the range of 50 to 95 wt. %, preferably in the range of 60 to 94 wt. %, and particularly preferably in the range of 65-93 wt. %, or 70 to 93 wt. %.

For component (C2), the proportion of C2-C5 alkenes is preferably in the range of 40 to 80 wt. % and particularly preferably in the range of 50 to 75 wt. %, the proportion of vinylaromatic monomers is preferably in the range of 20 to 60 wt. % and particularly preferably in the range of 25 to 50 wt. %.

If the monomers (M) are polymerized into the polymer chain, the proportion of (M) in component (C) is preferably in the range of 5 to 50 wt. %, particularly preferably in the range of 6-40 wt. %. If the monomers (M) are grafted onto the polymer chain, the proportion of (M) is preferably 0.1 to 5 wt. %, particularly preferably 0.2 to 4 wt. %.

The at least one polyolefin (C1) is based preferably on C2-C8 alkenes, particularly preferably on C2-C5 alkenes, in branched or unbranched form or a mixture thereof, and additionally at least one monomer (M) selected from the above-mentioned group.

According to a preferred embodiment the component (C1) is constructed exclusively from C2-C12, preferably C2-C8, particularly preferably C2-C5 alkenes, in branched or unbranched form or a mixture thereof, and additionally at least one monomer (M) selected from the group: maleic anhydride, itaconic anhydride, glycidyl acrylate, glycidyl methacrylate, acrylic acid, methacrylic acid, vinyl acetate, C1-C12 alkyl acrylates, C1-C12 alkyl methacrylates, or a mixture of such monomers, wherein preferably the monomer (M) is selected from the following group: maleic anhydride, glycidyl acrylate, glycidyl methacrylate, acrylic acid, methacrylic acid, vinyl acetate, C1-C12 alkyl acrylates.

If component (C1) is constructed exclusively of C2-C5 alkenes and component (C2) is constructed exclusively of vinylaromatic monomers and C2-C5 alkenes, then compounds are preferred in combination with additionally at least one monomer (M) selected from the following reduced group: maleic anhydride, glycidyl acrylate, glycidyl methacrylate, acrylic acid, methacrylic acid, vinyl acetate, ethyl acrylate, butyl acrylate or a mixture thereof. According to a further preferred embodiment, component (C1) is then constructed exclusively of alkenes selected from the following group: ethene, propene, 1-butene, 2-butene, 1-pentene, 2-pentene, and additionally at least one monomer (M) selected from the reduced group specified above, and/or component (C2) is then exclusively composed of alkenes selected from the following group: ethene, propene, 1-butene, 2-butene, 1-pentene, 2-pentene, as well as styrene as a vinylaromatic monomer and additionally at least one monomer (M) selected from the reduced group specified above.

The component (C1) may also comprise polymers carrying carboxylic acid, carboxylic acid anhydride or epoxy groups in the side chain. Preferred are such polymers (copolymers or graft copolymers) composed of monomers (M) containing carboxylic acid or carboxylic acid anhydride groups or epoxy groups and at least one alkene monomer, wherein both groups of monomers contain at least one polymerizable carbon-carbon double bond. Preferred epoxy group-containing monomers are glycidyl acrylate and glycidyl methacrylate. Preferred monomers containing carboxylic acid groups are acrylic acid and methacrylic acid. Preferred carboxylic acid anhydride group-containing monomers are maleic anhydride and itaconic anhydride.

Copolymers of glycidyl acrylate and/or glycidyl methacrylate and at least one further unsaturated C2-C12 alkene monomer containing at least one non-aromatic carbon-carbon double bond may also be used as component (C1). Preferably, component (C1) is a copolymer of glycidyl acrylate and/or glycidyl methacrylate and at least one further olefinically unsaturated alkene monomer, wherein the concentration of glycidyl acrylate and glycidyl methacrylate is in the range of 5 to 20 wt. %, preferably in the range of 6 to 16 wt. % and particularly preferably in the range of 7 to 14 wt. %, in relation to the copolymer. If the copolymer contains less than 5 wt. % glycidyl acrylate or glycidyl methacrylate, the reactivity of component (C1) is generally too low and the desired mechanical properties are not achieved. If the glycidyl acrylate or glycidyl methacrylate concentration of component (C1) exceeds a concentration of 20 wt. %, the processability, surface quality and mechanical properties generally deteriorate.

Furthermore, it is preferred that the olefinically unsaturated alkene monomer is a monounsaturated olefin, preferably an α-olefin, with 2 to 8, in particular with 2 to 5 carbon atoms. In particular, the copolymer (C1) contains, in addition to glycidyl acrylate and/or glycidyl methacrylate, at least one further olefinically unsaturated alkene monomer selected from the group consisting of ethene, propene, 1-butene, 2-butene, 1-pentene, 2-pentene, or a mixture thereof. Diene monomers within the meaning of alkene monomers include, for example, 1,3-butadiene, 2-methyl-1,3-butadiene, 2,3-dimethyl-1,3-butadiene, 1,3-pentadiene and isoprene. 1,3-butadiene and isoprene are preferred, in particular 1,3-butadiene (hereinafter referred to as butadiene). Systems based on mixtures of such diene monomers with alkenes having only one double bond are also possible.

The component (C1) is particularly preferably a copolymer of glycidyl methacrylate and ethene and, optionally, further olefinically unsaturated alkene monomers, wherein in preferred compounds the content of ethene is preferably in the range of 50 to 95 wt. %, preferably in the range of 60 to 94 wt. % and particularly preferred in the range of 65-93 wt. % or 70-93 wt. %.

Specific examples are copolymers (C1) of ethylene and glycidyl acrylate; ethylene and glycidyl methacrylate; ethylene, methyl methacrylate and glycidyl methacrylate; ethylene, methyl acrylate and glycidyl methacrylate; ethylene, ethyl acrylate and glycidyl methacrylate; ethylene, butyl acrylate and glycidyl methacrylate; ethylene, vinyl acetate and glycidyl methacrylate.

The following copolymers are particularly preferred for component (C):
polyolefins (C1) of ethylene and glycidyl methacrylate, preferably with a glycidyl methacrylate content of 7 to 14 wt. %, in relation to the sum of all monomers in the copolymer;
polyolefins (C1) of ethylene, vinyl acetate and glycidyl methacrylate, preferably 71-88 wt. % ethylene, 5-15 wt. % vinyl acetate and 7-14 wt. % glycidyl methacrylate, in relation to the sum of all monomers in the copolymer;
polyolefins (C1) of ethylene, methyl acrylate and glycidyl methacrylate, preferably 56-73 wt. % ethylene, 20-30 wt. % methyl acrylate and 7-14 wt. % glycidyl methacrylate, in relation to the sum of all monomers in the copolymer;
polyolefins (C1) of ethylene, butyl acrylate, glycidyl methacrylate, preferably 51-78 wt. % ethylene, 15-35 wt. % butyl acrylate and 7-14 wt. % glycidyl methacrylate, in relation to the sum of all monomers in the copolymer;
block copolymer (C2) of 20 to 60 wt. % styrene, 40 to 80 wt. % ethylene and butylene, grafted with 0.5 to 4 wt. % maleic anhydride;
or a mixture of such polyolefins (C1) and block copolymers (C2).

Generally speaking, component (C1) is preferably a copolymer of glycidyl acrylate and/or glycidyl methacrylate and at least one other unsaturated alkene monomer with at least one carbon-carbon double bond, wherein the concentration of glycidyl acrylate, glycidyl methacrylate or the mixture thereof is preferably in the range of 5 to 15 wt. %, preferably in the range of 7 to 14 wt. %, in relation to the sum of all monomers in the copolymer. The other unsaturated monomer may be a monounsaturated olefin, preferably an α-olefin, with 2 to 5 carbon atoms.

According to a very preferred embodiment, component (C1) is a copolymer of glycidyl methacrylate and ethene and, optionally, other olefinically unsaturated alkene monomers, wherein the content of alkene, preferably ethene, is in the range of 50 to 95 wt. %, preferably in the range of 60 to 94 wt. %.

Preferably, the melt flow rate (MFR) of component (C), determined according to ISO 1133 at 190° C. and a load of 2.16 kg, is in the range of 2-20 g/10 min, preferably in the range of 3-15 g/10 min.

Particularly preferred examples of components (C1) that may be used according to the invention are the systems available from Arkema under the product name Lotader AX, in particular of the type (AX8840 copolymer of 92% ethene and 8% glycidyl methacrylate) or of the type AX8900 (copolymer of 67% ethene, 25% methyl acrylate and 8% glycidyl methacrylate). Also preferred are products of the Elvaloy type from Dupont, in particular Elvaloy PTW (copolymer of 67% ethene, 28% butyl acrylate and 5% glycidyl methacrylate), as well as products of the Igetabond type available from Sumitomo, in particular Igetabond E (copolymer of 88% ethene and 12% glycidyl methacrylate).

Component (C) is also preferably constituted by copolymers or graft copolymers containing unsaturated carboxylic acids, dicarboxylic acids or carboxylic acid anhydrides as monomers, i.e., either these carboxylic acids, dicarboxylic acids or carboxylic acid anhydrides are polymerized with other comonomers to form copolymer (C), or a graft base based on other monomers has been modified by grafting with unsaturated carboxylic acids, dicarboxylic acids or carboxylic acid anhydrides.

Further examples of such copolymers or graft copolymers which may be used as a constituent of component (C) or may form component (C) as a whole are polybutadiene, polyisoprene, polyisobutylene, a copolymer of butadiene and/or isoprene with styrene or styrene derivatives and other comonomers, a hydrogenated copolymer and/or a copolymer formed by grafting or copolymerization with acid anhydrides, (meth)acrylic acid and esters thereof. The copolymer underlying component (C) may also be a graft rubber with a cross-linked elastomeric core consisting of butadiene or isoprene and having a graft shell of polystyrene, a non-polar or polar olefin homopolymer and copolymer such as ethylene-propylene rubber, ethylene-propylene-diene rubber, or a non-polar or polar olefin homopolymer and copolymer produced by grafting or copolymerization with acid anhydrides, (meth)acrylic acid and esters thereof. The copolymer may also be a carboxylic acid-functionalized copolymer such as poly(ethene-co-(meth)acrylic acid) or poly(ethene-co-1-olefin-co-(meth)acrylic acid), wherein the 1-olefin is an alkene or an unsaturated (meth)acrylic acid ester with more than 4 C atoms, including such copolymers in which the acid groups are partially neutralized with metal ions.

Preferred copolymers (C2) based on alkenyl aromatic monomers (styrene and styrene derivatives) and C2-C5 alkenes are block copolymers composed of alkenyl aromatic compounds and a C2-C5 alkene, preferably conjugated diene, as well as hydrogenated block copolymers composed of the alkenyl aromatic compound and alkenes, preferably conjugated dienes, or combinations of these block copolymer types. The block copolymer contains at least one block derived from the alkenyl aromatic compound and at least one block derived from a C2-C5 alkene, preferably a conjugated diene. In the hydrogenated block copolymers, the proportion of aliphatically unsaturated carbon-carbon double bonds has been reduced by hydrogenation. Two-, three-, four-and polyblock copolymers with a linear structure are suitable as block copolymers. However, branched and star-shaped structures may also be used according to the invention. Branched block copolymers are obtained in a known manner, e.g., by grafting polymeric “side branches” onto a polymer main chain.

In addition to or in mixture with styrene, vinyl aromatic monomers substituted on the aromatic ring and/or on the C═C double bond with C1-20 or C1-C10 hydrocarbon groups or halogen atoms may also be used as alkenyl aromatic monomers.

Examples of alkenyl aromatic monomers under the term substituted or unsubstituted styrene are preferably unsubstituted styrene, p-methylstyrene, α-methylstyrene, ethylstyrene, tert-butylstyrene, bromostyrenes, chlorostyrenes, and combinations thereof. Preferred are unsubstituted styrene, p-methylstyrene, alpha-methylstyrene, ethylstyrene, tert-butylstyrene, or mixtures thereof. Styrene is particularly preferably used.

Styrene is preferably used as the alkenyl aromatic monomer and butadiene as the alkene, preferably diene monomer, i.e., the styrene-butadiene block copolymer is preferred. As a rule, the block copolymers are produced by anionic polymerization in a manner known per se.

In addition to the styrene and diene monomers, further comonomers may also be used. The proportion of comonomers is preferably 0 to 50, particularly preferably 0 to 30 and especially 0 to 15 wt. %, in relation to the total amount of monomers used. Suitable comonomers are, for example, acrylates, in particular C1-12-alkyl acrylates such as n-butyl acrylate or 2-ethylhexyl acrylate, and the corresponding methacrylates, in particular C1-12-alkyl methacrylates such as methyl methacrylate (MMA). Other possible comonomers are (meth)acrylonitrile, glycidyl (meth)acrylate, vinyl methyl ether, diallyl and divinyl ethers of bifunctional alcohols, divinylbenzene and vinyl acetate. C1-12 alkyl acrylates and C1-12 alkyl methacrylates are collectively referred to as C1-12 alkyl (meth)acrylates.

In addition to the conjugated diene, the hydrogenated block copolymers (C2) may also contain proportions of low-molecular-weight hydrocarbons such as ethylene, propylene, 1-butene, dicyclopentadiene or non-conjugated dienes. In the hydrogenated block copolymers, the proportion of non-reduced aliphatic unsaturated bonds is less than 50%, preferably less than 25%, and in particular less than 10%. The aromatic proportions are reduced to a maximum of 25%. The hydrogenated block copolymers styrene-(ethylene-butylene) or styrene-(ethylene-propylene) diblock and styrene-(ethylene-butylene)-styrene triblock copolymers are obtained by hydrogenation of styrene-butadiene and styrene-butadiene-styrene copolymers.

The block copolymers (C2) preferably consist of 20 to 60 wt. % of aromatic block, in particular 25 to 55 wt. % of aromatic block. The diene may be incorporated into the conjugated diene proportion in 1,2 or 1,4 orientations.

The molar mass of component (C) is preferably 5,000 to 500,000 g/mol, particularly preferably 20,000 to 300,000 g/mol and in particular preferably 40,000 to 200,000 g/mol.

Suitable hydrogenated block copolymers are commercially available products such as KRATON® (Kraton Polymers) G1650, G1651, G1652 and FG1901GT as well as TUFTEC® (Asahi Chemical) H1041, H1043, H1052, H1062, H1141 and H1272.

Examples of non-hydrogenated block copolymers are polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(α-methylstyrene-polybutadiene-poly(α-methylstyrene), as well as combinations thereof.

Suitable non-hydrogenated block copolymers that are commercially available include various products with the brand names SOLPRENE® (Phillips), KRATON® (Shell), VECTOR® (Dexco) and SEPTON® (Kuraray).

According to a further preferred embodiment, the moulding compounds according to the invention are characterized in that component (C1) is a polyolefin homopolymer or an ethylene-α-olefin copolymer, in particular preferably an EP and/or EPDM elastomer (ethylene-propylene rubber or ethylene-propylene-diene rubber). For example, it may be an elastomer based on an ethylene-C3-12-α-olefin copolymer with 20 to 96, preferably 25 to 85 wt. % ethylene, wherein the C3-12-α-olefin is particularly preferably an olefin selected from the group consisting of propene, 1-butene, 1-pentene, 1-hexene, 1-octene, 1-decene and/or 1-dodecene, and component (C) is particularly preferably a grafted ethylene-propylene or ethylene-butylene rubber and/or LLDPE and/or VLDPE.

Alternatively or additionally (for example in mixture), component (C1) may contain a terpolymer based on ethylene-C3-12-α-olefin with an unconjugated diene, which preferably contains 25 to 85 wt. % ethylene and up to a maximum of 10 wt. % of an unconjugated diene, wherein the C3-12-α-olefin is particularly preferably an olefin selected from the group consisting of propene, 1-butene, 1-pentene, 1-hexene, 1-octene, 1-decene and/or 1-dodecene, and/or wherein the unconjugated diene is preferably selected from the group consisting of bicyclo(2.2.1) heptadiene, hexadiene-1.4, dicyclopentadiene and/or, in particular, 5-ethylidenenorbornene.

Ethylene-acrylate copolymers containing at least one further monomer (M) as comonomer are also suitable as constituents for component (C1).

Other possible forms as constituents for component (C1) are ethylene-propylene copolymers and ethylene-butylene copolymers or mixtures (blends) containing such systems, wherein such systems are modified (grafting, copolymerization) with at least one monomer (M).

In addition to the constituents mentioned, all copolymers (C) described above may also contain components with dicarboxylic acid anhydride, dicarboxylic acid or dicarboxylic acid monoalkyl ester groups in a concentration sufficient for good bonding to the polyamide (A) and to the polyamide (B).

The monomers (M) with dicarboxylic acid anhydride, dicarboxylic acid or carboxylic acid groups are either grafted onto the main chain polymer (polyolefin, vinylaromatic block copolymer) in a grafting reaction, wherein further monomers may be present during the grafting reaction, or introduced into component (C) by copolymerization of an unsaturated dicarboxylic acid anhydride, an unsaturated dicarboxylic acid or an unsaturated dicarboxylic acid monoalkyl ester with other monomers as mentioned above, wherein the monomers (M) are preferably selected from the following group: maleic acid, maleic anhydride, maleic acid monobutyl ester, fumaric acid, aconitic acid and/or itaconic anhydride.

Preferably, component (C) is grafted with 0.1 to 5 wt. % of an unsaturated anhydride. In general, the grafting degree is preferably in the range of 0.1-5%, particularly preferably in the range of 0.2-4%.

A mixture of an ethylene-propylene copolymer and an ethylene-butylene copolymer is also possible as a constituent of component (C), preferably with a maleic anhydride grafting degree (MAH grafting degree) in the range of 0.3-0.9%.

The possible systems for component (C) indicated above may also be used in mixtures.

Examples of commercially available polyolefins (C1) that may be used as constituents of component (C) are:
TAFMER MC201: g-MAH (0.6%) blend of 67% EP copolymer (20 mol % propylene)+33% EB copolymer (15 mol % butene-1)): Mitsui Chemicals, Japan.
TAFMER MH5010: g-MAH (0.6%) ethylene-butylene copolymer; Mitsui.
TAFMER MH7010: g-MAH (0.7%) ethylene-butylene copolymer; Mitsui.
TAFMER MH7020: g-MAH (0.7%) EP copolymer, Mitsui.
EXXELOR VA1801: g-MAH (0.7%) EP copolymer; Exxon Mobile Chemical, US.
EXXELOR VA1803: g-MAH (0.5-0.9%) EP copolymer, amorphous, Exxon.
EXXELOR VA1810: g-MAH (0.5%) EP copolymer, Exxon
EXXELOR MDEX 94-11: g-MAH (0.7%) EPDM, Exxon.
FUSABOND MN493D: g-MAH (0.5%) ethylene-octene copolymer, DuPont, US. FUSABOND A EB560D (g-MAH) ethylene-n-butyl acrylate copolymer, DuPont. ELVALOY, DuPont.

An ionomer in which the polymer-bound carboxyl groups are wholly or partially linked to each other by metal ions is also preferred.

Particularly preferred are copolymers of butadiene with styrene functionalized by grafting with maleic anhydride, non-polar or polar olefin homopolymers and copolymers produced by grafting with maleic anhydride, and carboxylic acid-functionalized copolymers such as poly(ethene-co-(meth)arylic acid) or poly(ethene-co-1-olefin-co-(meth)acrylic acid), in which the acid groups are partially neutralized with metal ions.

Preferably, component (C1) contains the C2-C12 alkenes, in branched or unbranched form, or a mixture thereof, preferably the ethylene, propylene, butylene, or a mixture thereof (considered as a sum in the case of a mixture) in a range of 50-95 wt. %, preferably in a range of 60 to 94 wt. %, and particularly preferably in a range of 65-93 wt. %, or 70 to 93 wt. %, wherein, in particular, preferably only ethylene is present.

### Component (D)

The component (D) contained in the polyamide moulding compound, which is optional up to an amount of 5 wt. %, in relation to the sum of components (A)-(D), is preferably selected from the following group: UV stabilizers, heat stabilizers, radical scavengers, antioxidants, processing aids, anti-blocking agents, lubricants, mould release agents, plasticizers, antistatic agents, fillers, such as in particular particulate fillers including nanoscale fillers and/or additives, flame retardants, in particular halogen-free flame retardants, dyes, pigments, residues from polymerization processes such as catalysts, salts and their derivatives or mixtures thereof.

Preferably, the polyamide moulding compound for coating the metal element does not contain any flame retardants based on red phosphorus or magnesium hydroxide. Preferred phosphorus-containing flame retardants are metal phosphinates, in particular calcium, aluminium or zinc phosphinates, which may be used in combination with synergists such as melamine cyanurate, melamine polyphosphate or zinc borate.

It is also preferred if the proportion of component (A) is in the range of 48 to 83 wt. %, preferably in the range of 53 to 81 wt. %, and/or the proportion of component (B) is in the range of 9 to 32 wt. %, preferably in the range of 10 to 30 wt. %, and/or the proportion of component (C) is in the range of 8 to 17 wt. %, preferably in the range of 9 to 15 wt. %, and/or that the proportion of component (D) is in the range of 0 to 3 wt. %, preferably in the range of 0 to 2 wt. %.

A polyamide moulding compound consisting of components (A), (B) and (C) and, optionally, (D) is particularly preferred:
(A) 48-83 wt. % of at least one semi-crystalline polyamide selected from the group of homopolyamides PA46, PA66, PA610, PA612;
(B) 9-32 wt. % of at least one amorphous polyamide based on aliphatic diamines with 6 to 24 carbon atoms and aliphatic and/or aromatic dicarboxylic acids with 6 to 36 C atoms, and optionally lactams and/or α,ω aminocarboxylic acids;
(C) 8-17 wt. % of at least one polyolefin (C1) based on C2-C12 alkenes and/or at least one block copolymer (C2) based on vinylaromatic monomers and C2-C5 alkenes, or a mixture thereof, wherein the stated alkenes may be present in branched or unbranched form, and
wherein the vinylaromatic block copolymers (C2) and/or the polyolefins (C1) contain at least one additional monomer (M) selected from the group consisting of maleic anhydride, itaconic anhydride, glycidyl acrylate, glycidyl methacrylate, acrylic acid, methacrylic acid, vinyl acetate, C1-C12 alkyl acrylates, preferably ethyl acrylate or butyl acrylate, C1-C12 alkyl methacrylates, or a mixture of such monomers, and
wherein these additional monomers (M) may be arranged in the polymer chain or grafted onto the polymer chain;
(D) 0-3 wt. % additives, differing from components (A) to (C),
with the provision that the sum of components (A)-(D) is 100 wt. %.

According to a further preferred embodiment, the metal element of the layer structure is selected from a metal from the following group: aluminium, copper, silver, zinc, iron, steel, or mixtures or alloys thereof. The surface may be actively or passively oxidized and/or galvanized.

According to a further aspect, the present invention relates to a layer structure (1) with at least one metal element (2) and at least one polyamide layer (3) formed from a polyamide moulding compound according to the invention as described above.

It is particularly preferred that the metal element is enclosed by the polyamide layer. The metal element may, for example, be formed as an (endless) metal conductor, with the polyamide moulding compound encasing the metal element. It is particularly preferred that the polyamide moulding compound is in direct contact with the metal element, but it may also be advantageous if a further layer (4) is arranged between the metal element and the polyamide layer—as described in detail below. If the further layer (4) is located between the metal element and the polyamide layer, it is also referred to as an intermediate layer.

Preferably, the polyamide layer is formed directly adjacent to and without an additional adhesion-promoting layer (interlayer) on the metal element. Directly adjacent also includes situations in which the metal element has an oxide layer on its surface, as well as situations in which the metal element without an oxide layer is directly adjacent to the polyamide layer.

According to a further preferred embodiment of the present invention, the metal element is a metal profile, in particular an endless metal profile, preferably in the form of a wire or flat conductor, which is preferably covered on the outside over its entire circumference by the polyamide layer. The conductor may also be a waveguide.

In particularly preferred compounds, such a conductor is an electrical conductor in which the thickness of the polyamide layer, measured perpendicular to the main direction of the conductor, is preferably in the range of 0.1-2 mm, preferably in the range of 0.25-1.25, and particularly preferably in the range of 0.3 to 1 mm. The core of such a conductor typically has a diameter in the range of 0.2-10 mm, preferably in the range of 0.2-4 mm, in the case of a cylindrical wire. In the case of a flat conductor, it typically has a width in the range of 10-30 mm and a thickness in the range of 2-10 mm.

Preferably, the layer structure is an electrical line for motor vehicles in the high-voltage range, or the present invention relates to the use of such a layer structure for such purposes. This means that the electrical conductor is intended or used to carry a voltage of no more than 1500 volts in the case of direct current or a voltage of no more than 1000 volts in the case of alternating current. However, the layer structure according to the invention is also suitable for the low-voltage range up to a maximum of 60 volts. Particularly preferred applications of the layer structure or embodiments of the layer structure are: Battery cables or charging cables for motor vehicles, cabling within an electric motor vehicle, charging infrastructure for electric vehicles.

The metal element may be formed from a metal selected from the following group or may comprise or contain these: aluminium, copper, silver, zinc, iron, steel, or mixtures or alloys thereof, wherein the surface may be oxidized and/or galvanized.

The layer structure (1) may have one of the following structures:
metal element (2)/polyamide layer (3); or
metal element (2)/polyamide layer (3)/further layer (4); or
metal element (2)/further layer (4)/polyamide layer (3); or
metal element (2)/further layer (4)/polyamide layer (3)/further layer (4);
wherein said further layer is formed to an extent of at least 50 wt. % from a thermoplastic moulding compound which is different from the polyamide moulding compound according to the invention. If the layer structure (1) contains two further layers (4), these may be formed from the same or different moulding compounds.

The present invention additionally relates to a method for producing a layer structure (1) as described above, wherein the metal element (2), preferably in the form of a continuous profile, in particular in the form of a wire or flat conductor, is coated with the polyamide layer (3) in an extrusion process, preferably around the entire circumference of the metal element (2), preferably by feeding the continuous profile from a roll together with the material of the polyamide layer and the optional further layers (4) through an extrusion die.

Prior to extrusion coating, the metal element is cleaned and degreased, preferably with the aid of cleaning baths which may contain solvent and/or acidic or alkaline aqueous solutions, in order to improve adhesion to the polyamide layer, then is dried and preheated to a temperature in the range of 130 to 280° C., preferably 150 to 260° C., and particularly preferably 170 to 240° C. The metal element is preferably heated with hot air, flame or microwaves (high-frequency preheating).

Accordingly, the polyamide layer is preferably not a film or a tube which is manufactured separately, for example before being connected to the metal element, and forms a self-supporting structure, and is then applied directly or indirectly to the metal element using an adhesive agent or by partial melting, softening or shrinking.

Lastly, the present invention also relates to the use of a polyamide moulding compound according to the invention for producing a polyamide layer on a metal element, in particular for producing an electrical conductor insulated with the polyamide layer.

The polyamide layer may be arranged directly or indirectly (i.e., separated by a further layer, as described above) on the metal element.

The further specifications of components (A)-(D), as described above in conjunction with the multi-layer structure, apply equally and analogously to the use covered by the invention. Here, too, it is not preferable to first produce the polyamide layer as a self-supporting film or self-supporting tube and then connect it to the metal element. Preferably, therefore, it is not a matter of using the polyamide layer as a film or tube, but rather of applying the polyamide moulding compound directly from the molten phase to the metal element (extrusion, dip coating, etc.), or alternatively, it is a matter of arranging the polyamide moulding compound as a solid (powder, granulate) on the metal element and then converting it directly into a polyamide layer on this element. Preferably, therefore, the invention relates to uses in which the polyamide layer is produced in situ on the metal element, which in turn ensures optimum adhesion, preferably without the use of an adhesion promoter or an adhesion-promoting intermediate layer.

The present invention is explained in more detail with reference to the following embodiments, without limiting the invention to the specific embodiments.

### Production of the Polyamide Moulding Compounds

The component of type (A) was compounded with the component (B), the component (C), and the additives of the component (D) in the proportions indicated in the following tables according to the following method. The following were used:

### Component A

P-1 Radipol A45, polyamide PA66, relative viscosity=1.86, Tm=260° C., Radici
P-2 Grilamid 2S, polyamide PA610, relative viscosity=1.95, Tm=222° C., EMS CHEMIE
P-3 Grilamid 2D, polyamide PA612, relative viscosity=1.80, Tm=212° C., EMS CHEMIE
P-4 Grilamid 1S, polyamide PA1010, relative viscosity=1.75, Tm=200° C., EMS CHEMIE

### Component B

P-5 PA 6I/6T/MACMI/MACMT/PACMI/PACMT/12 (39:39:7:7:2.5:2.5:3), relative viscosity=1.61, Tg=160° C., EMS CHEMIE
P-6 PA 6I/6T (67:33), rel. viscosity=1.54, Tg=125° C., EMS CHEMIE
P-7 PA MACM10, relative viscosity=1.72, Tg=160° C., EMS CHEMIE
P-8 PA MACM10/1010 (66:34), relative viscosity=1.77, Tg=118° C., EMS CHEMIE
P-9 MACMI/MACMT/MACM12/MACM36 (28:28:40:4), relative viscosity=1.62, Tg=200° C., EMS CHEMIE
P-10 MACM12, relative viscosity=1.84, Tg=154° C., EMS CHEMIE

### Component C

P-11 Lotader AX8840, copolymer of ethylene (92%) and glycidyl methacrylate (8%), Arkema
P-12 Kraton FG1901GT, styrene block copolymer SEBS-g-MAH (30% styrene, 70% EB, 1.7% maleic anhydride (based on SEBS)), Kraton Polymers

### Component D

### Add Mixture (1:1) of Irganox 1098, BASF and Naugard 445, SI Group

The raw materials of components (A), (C) and (D) were pre-blended and gravimetrically metered via a belt scale into the feeder of a twin screw extruder, from Werner & Pfleiderer, model ZSK 25. Two zones upstream from the nozzle, the melt was degassed at atmospheric pressure (open degassing zone). It was processed at cylinder temperatures of 250-290° C., at a screw speed of 200 rpm, and at a throughput of 12 kg/h. The compound was discharged via a nozzle and granulated after the strand was cooled. It was subsequently dried for 24 h in vacuum at 80° C.

### Production of the Moulded Articles

The production of the moulded articles was carried out on an injection moulding machine, Arburg Allrounder 320-210-750, with an increasing cylinder temperature profile of 240-290° C. and injection pressures of 1200-1800 bar. The moulding temperature was 80° C. The geometry of the moulded articles corresponds to the specifications of the corresponding test standards.

The measurements were carried out in accordance with the following standards and on the following test specimens.

The MVR (Melt Volume Rate) is determined according to ISO 1133 (2012) by means of a capillary rheometer, wherein the material (granules) were melted in a heatable cylinder at a temperature of 275° C. and pressed at a pressure resulting from the bearing load of 5 kg through a defined nozzle (capillary). The emerging volume of the polymer melt was determined as a function of time.

The thermal behavior (melting point) (TM), melting enthalpy (ΔHm), glass transition temperature (Tg)) was determined on the granules according to ISO-Norm 11357:2013 (11357-2 for the glass transition temperature, 11357-3 for the melting temperature and the melting enthalpy). Differential scanning calorimetry (DSC) was carried out with a heating rate of 20° C./min.

The relative viscosity (ηrel) was determined according to DIN EN ISO 307:2007 on solutions of 0.5 g polymer dissolved in 100 ml m-cresol at a temperature of 20° C. Granules are used as the sample. The MVR (melt volume flow rate) is determined according to ISO 1133 at 275° C. and a load of 5 kg on the granules.

Tensile modulus of elasticity, breaking strength, and elongation at break: Tensile modulus of elasticity, breaking strength, and elongation at break were determined according to ISO 527 (2012) at a traction speed of 1 mm/min (tensile modulus of elasticity) or at a traction speed of 50 mm/min (breaking strength, elongation at break) on the ISO tensile bar, standard ISO/CD 3167, type Al, 170×20/10×4 mm, at a temperature of 23° C.

Impact strength, notch impact strength according to Charpy were measured according to ISO 179/1 (2023) or ISO 179/2 (2020) on the ISO test bar, standard ISO/CD 3167, type B1, 80×10×4 mm, at a temperature of 23° C. and −30° C.

The specific volume resistivity was determined in accordance with DIN EN 62631-3-1 (2017) using test specimens with dimensions of 100×100×3 mm. The values given correspond to the average of measurements taken on 3 test specimens each. The measurements were carried out using a high-impedance measuring electrode FE 50 and a measuring device TO3 from H.P. Fischer Elektronik GmbH & Co. In order to determine the specific volume resistivity at different temperatures, the measuring electrode was placed in an oven. After heating to the specified measurement temperature, the test specimen was stored at this temperature for 20 minutes prior to measurement. In addition, the test specimens were stored in an oven at 180° C. for a period of 3000 hours and the specific volume resistivity was subsequently determined at 20° C. and 180° C.

The chemical resistance to a mixture of 85% ethanol and 15% ISO 1817 Liquid C (50 vol % 2,2,4-trimethylpentane, 50 vol % toluene) and to a power steering fluid (ISO 1817, Oil No. 3) was tested in accordance with ISO 6722-1 Class C Methods 1 and 2 on a sheathed aluminium wire with a diameter of 4 mm, a sheath of 0.5 mm (outer diameter: 5 mm) and a length of 600 mm. Method 1: After storing the test specimens in the test fluid (10 seconds) at room temperature (ethanol-liquid C mixture) or 50° C. (power steering fluid) and then allowing them to drip-dry (3 minutes), the test specimens were stored at 125° C. for 240 hours. After cooling, the treated aluminium wire was bent over several windings onto a 10 mm mandrel (radius: 5 mm). The sheath was then subjected to a visual inspection for cracks or other changes. The wound wire was then subjected to a dielectric strength test (1 kV, 1 minute) after being stored for 10 minutes in a salt solution (1% sodium chloride). Method 2: The test specimens were stored in the test fluid for 20 hours at 23° C. (ethanol, Liquid C) or for 20 hours at 50° C. (power steering fluid). After drying (30 minutes of drip-drying) the test specimens at 23° C., the bending test was performed, followed by the dielectric strength test (1 kV, 1 minute) as described in Method 1.

Production of a sheathed aluminium wire for determining chemical resistance: A compact aluminium wire with a diameter of 4.0 mm made of pure aluminium (Al 99.5) was degreased and dried prior to coating. The aluminium conductor was then heated to 200° C. by flame treatment and extrusion-coated with the polyamide variants on a wire coating installation (Nokia Cable Machinery SCL-20 machine with the following set-up: MPP30-24D-305 extruder with a screw diameter of 30 mm and screw pitch L/D 25:1; extrusion head: Nokia Cable Machinery NXH 3 cross-injection head, nozzle diameter 10.0 mm, core diameter 6.0 mm; cooling bath water temperature 30° C., distance between nozzle and cooling bath 85 cm; conductor preheating by flame treatment with ring flame nozzle, propane-oxygen burner) with a layer thickness of 0.5 mm. The draw-off speed was 5 m/min, the nozzle temperature was 270° C. and the extrusion zones were set to a temperature of 240 to 270° C.

The test specimens produced from components (A) to (D) were compounded in accordance with the following tables and tested for chemical resistance in accordance with the test methodology described above. The quantities of the respective components and the measurement results obtained are shown in Tables 1 and 2 below.

TABLE 1

| Components | Unit | CE1 | B1 | B2 | B3 | B4 | B5 | CE2 |
|---|---|---|---|---|---|---|---|---|
| P-1 (component A) | wt. % | | 67 | 57 | 67 | 57 | 67 | 75 |
| P-10 (component B) | wt. % | 87.6 | | | | | | |
| P-5 (component B) | wt. % | | | | 20 | 30 | 20 | 24 |
| P-6 (component B) | wt. % | | 20 | 30 | | | | |
| P-11 (component C) | wt. % | 12.4 | 12 | 12 | 12 | 12 | | |
| P-12 (component C) | wt. % | | | | | | 12 | |
| Add (component D) | wt. % | | 1.0 | 1.0 | 1.0 | 1.0 | 1.0 | 1.0 |

Properties

| | | | | | | | | |
|---|---|---|---|---|---|---|---|---|
| MVR (275° C./5 kg) | cm³/ | 18 | 70 | 58 | 45 | 32 | 49 | 56 |
| | 10 min | | | | | | | |
| Tensile modulus | MPa | 1300 | 2300 | 2220 | 2300 | 2200 | 2300 | 2820 |
| of elasticity | | | | | | | | |
| Breaking strength | MPa | 45 | 45 | 42 | 47 | 44 | 48 | 54 |
| Elongation at break | % | 120 | 20 | 17 | 17 | 13 | 12 | 44 |
| Impact strength | kJ/m² | n/a | n/a | n/a | n/a | n/a | n/a | n/a |
| 23° C. | | | | | | | | |
| Impact | kJ/m² | | n/a | n/a | n/a | n/a | n/a | 62 |
| strength −30° C. | | | | | | | | |
| Notch impact | kJ/m² | 56 | 15.4 | 15.8 | 14 | 16 | 19 | 5.4 |
| strength 23° C. | | | | | | | | |
| Notch impact | kJ/m² | | 8.9 | 10.0 | 9 | 10 | 13 | 3.8 |
| strength −30° C. | | | | | | | | |
| Specific volume | Ωm | 2.2E15 | 2.3E15 | 6.3E14 | 9.3E14 | 4.8E14 | 1.2E15 | 1.5E15 |
| resistivity 23° C. | | | | | | | | |
| (DIN EN 62631-3-1) | | | | | | | | |
| Specific volume | Ωm | 6.2E11 | 1.1E13 | 1.7E13 | 1.5E13 | 3.5E13 | 1.7E13 | 1.0E13 |
| resistivity 130° C. | | | | | | | | |
| Specific volume | Ωm | n.m. | 8.7E12 | 1.1E13 | 1.2E13 | 2.9E13 | 3.4E12 | 2.5E10 |
| resistivity 180° C. | | | | | | | | |
| Specific volume | Ωm | n.m. | 6.4E13 | 7.7E13 | 1.9E11 | 1.4E14 | 5.6E13 | 3.7E13 |
| resistivity 20° C., | | | | | | | | |
| after storage for | | | | | | | | |
| 3000 h, 180° C. | | | | | | | | |
| Specific volume | Ωm | n.m. | 5.8E10 | 2.1E11 | 1.9E11 | 1.2E13 | 1.6E11 | 1.1E10 |
| resistivity 180° C., | | | | | | | | |
| after storage for | | | | | | | | |
| 3000 h, 180° C. | | | | | | | | |
| Chem. resistance | | failed | passed | passed | passed | passed | passed | failed |
| according to | | | | | | | | |
| ISO6722-1 Class C | | | | | | | | |
| Method 2 (20 h, | | | | | | | | |
| 23° C.) (Ethanol/ | | | | | | | | |
| ISO1817 Liquid C) | | | | | | | | |
| Chem. resistance | | failed | passed | passed | passed | passed | passed | failed |
| according to | | | | | | | | |
| ISO6722-1 Class C | | | | | | | | |
| Method 1 (240 h, | | | | | | | | |
| 125° C.) (Ethanol/ | | | | | | | | |
| ISO1817 Liquid C) | | | | | | | | |
| Chem. resistance | | failed | passed | passed | passed | passed | passed | failed |
| according to | | | | | | | | |
| ISO6722-1 Class C | | | | | | | | |
| Method 2 (20 h, | | | | | | | | |
| 23° C.) (power | | | | | | | | |
| steering fluid) | | | | | | | | |
| Chem. resistance | | failed | passed | passed | passed | passed | passed | failed |
| according to | | | | | | | | |
| ISO6722-1 Class C | | | | | | | | |
| Method 1 (240 h, | | | | | | | | |
| 125° C.) (power | | | | | | | | |
| steering fluid) | | | | | | | | |

passed = test passed; failed = test failed
n.m. = not measurable (sample does not have sufficient mechanical strength)

TABLE 2

| Components | Unit | B6 | B7 | B8 | B9 | B10 | B11 | B12 |
|---|---|---|---|---|---|---|---|---|
| P-1 (component A) | wt. % | 76 | | | | | | |
| P-2 (component A) | wt. % | | 67 | | 67 | | 67 | |
| P-3 (component A) | wt. % | | | | | 67 | | 67 |
| P-4 (component A) | wt. % | | | 67 | | | | |
| P-5 (component B) | wt. % | 11 | | | 20 | 20 | | |
| P-6 (component B) | wt. % | | | | | | | |
| P-7 (component B) | wt. % | | | | | | 20 | |
| P-8 (component B) | wt. % | | 20 | 20 | | | | |
| P-9 (component B) | wt. % | | | | | | | 20 |
| P-11 (component C) | wt. % | 12 | 12 | 12 | 12 | 12 | 12 | 12 |
| P-12 (component C) | wt. % | | | | | | | |
| Add (component D) | wt. % | 1.0 | 1.0 | 1.0 | 1.0 | 1.0 | 1.0 | 1.0 |

Properties

| | | | | | | | | |
|---|---|---|---|---|---|---|---|---|
| MVR (275° C./5 kg) | cm³/ | 62 | 24 | 51 | 36 | 88 | 24 | 42 |
| | 10 min | | | | | | | |
| Tensile modulus | MPa | 2420 | 1780 | 1490 | 1800 | 2000 | 1790 | 1750 |
| of elasticity | | | | | | | | |
| Breaking strength | MPa | 48 | 44 | 51 | 49 | 41 | 44 | 49 |
| Elongation at break | % | 15.6 | 150 | 240 | 210 | 90 | 100 | 80 |
| Impact strength | kJ/m² | n/a | n/a | n/a | n/a | n/a | n/a | n/a |
| 23° C. | | | | | | | | |
| Impact | kJ/m² | n/a | n/a | n/a | n/a | n/a | n/a | n/a |
| strength −30° C. | | | | | | | | |
| Notch impact | kJ/m² | 11.1 | 13.0 | 12.3 | 14.2 | 11.8 | 13.8 | 16.6 |
| strength 23° C. | | | | | | | | |
| Notch impact | kJ/m² | 9.0 | 8.5 | 8.0 | 13.7 | 8.4 | 8.8 | 9.8 |
| strength −30° C. | | | | | | | | |
| Specific volume | Ωm | 1.3E15 | 3.3E15 | 2.7E15 | 9.8E14 | 7.9E14 | 2.0E15 | 1.3E15 |
| resistivity 23° C. | | | | | | | | |
| (DIN EN 62631-3-1) | | | | | | | | |
| Specific volume | Ωm | 2.3E13 | 1.8E13 | 2.7E13 | 1.6E13 | 3.1E13 | 2.8E13 | 1.7E14 |
| resistivity 130° C. | | | | | | | | |
| Specific volume | Ωm | 1.4E13 | 1.3E13 | 2.4E13 | 1.4E13 | 1.9E13 | 1.7E13 | 1.4E13 |
| resistivity 180° C. | | | | | | | | |
| Specific volume | Ωm | 1.2E14 | 2.0E14 | 1.7E14 | 1.3E14 | 1.8E14 | 2.2E14 | 2.8E14 |
| resistivity 20° C., | | | | | | | | |
| after storage for | | | | | | | | |
| 3000 h, 180° C. | | | | | | | | |
| Specific volume | Ωm | 3.4E11 | 4.5E11 | 2.1E11 | 1.9E11 | 7.6E11 | 5.2E11 | 6.4E11 |
| resistivity 180° C., | | | | | | | | |
| after storage for | | | | | | | | |
| 3000 h, 180° C. | | | | | | | | |
| Chem. resistance | | passed | passed | passed | passed | passed | passed | passed |
| according to | | | | | | | | |
| ISO6722-1 Class C | | | | | | | | |
| Method 2 (20 h, | | | | | | | | |
| 23° C.) (Ethanol/ | | | | | | | | |
| ISO1817 Liquid C) | | | | | | | | |
| Chem. resistance | | passed | passed | passed | passed | passed | passed | passed |
| according to | | | | | | | | |
| ISO6722-1 Class C | | | | | | | | |
| Method 1 (240 h, | | | | | | | | |
| 125° C.) (Ethanol/ | | | | | | | | |
| ISO1817 Liquid C) | | | | | | | | |

As can be seen from the test results, sufficient chemical and thermal resistance may only be achieved if components (A) to (D) are present together in the specified weight ratios.

1-15. (canceled)

16. A polyamide moulding compound, wherein the polyamide moulding compound comprises the following components (A), (B) and (C), and optionally (D):
(A) 40-85 wt. % of at least one semi-crystalline polyamide selected from the group consisting of homopolyamides PA46, PA66, PA610, PA612, PA1010, and
PA1012 and copolyamides PA 66/6T and PA 66/6I/6T;
(B) 8-35 wt. % of at least one amorphous polyamide based on aliphatic diamines with 6 to 24 carbon atoms and aliphatic and/or aromatic dicarboxylic acids with 8 to 12 C atoms, and optionally lactams and/or α,ω aminocarboxylic acids;
(C) 7-20 wt. % of at least one polyolefin (C1) based on C2-C12 alkenes and/or at least one block copolymer (C2) based on vinylaromatic monomers and C2-C5 alkenes, or a mixture thereof, wherein said alkenes are branched or unbranched alkenes, and
wherein polyolefin (C1) and/or vinylaromatic block copolymer (C2) contains or contain at least one additional monomer (M) selected from the group consisting of maleic anhydride, itaconic anhydride, glycidyl acrylate, glycidyl methacrylate, acrylic acid, methacrylic acid, vinyl acetate, C1-C12 alkyl acrylates, and C1-C12 alkyl methacrylates, and
wherein these additional monomers (M) may be arranged in the polymer chain or grafted onto the polymer chain;
0-5 wt. % additives (D), differing from components (A) to (C),
with the proviso that the sum of components (A)-(D) is 100 wt. %.

17. The polyamide moulding compound according to claim 16, wherein
polyamide (A) is selected from PA66, PA610, and PA612;
and/or
polyamide (B) is selected from the group consisting of PA 6I/6T, PA MACM10, PA MACM12, PA MACM14, PA MACM10/1010, PA MACM12/1012, PA MACM14/1014, PA MACMI/12, PA MACMI/MACM12, PA MACMI/MACMT/MACM12, PA MACMI/MACMT/12, PA MACMI/MACMT/MACM12/MACM36, PA 6I/6T/MACMI/MACMT/PACMI/PACMT/12, and PA 6I/6T/612/MACMI/MACMT/MACM12.

18. The polyamide moulding compound according to claim 16, wherein polyolefin (C1) is a polyolefin based on C2-C8 alkene.

19. The polyamide moulding compound according to claim 16, wherein, in polyolefin (C1), the proportion of C2-C12 alkene is in the range of 50-95 wt. %.

20. The polyamide moulding compound according to claim 16, wherein
the at least one polyolefin (C1) is constructed exclusively from C2-C12 alkene, in branched or unbranched form, and additionally at least one monomer (M) selected from the group consisting of maleic anhydride, itaconic anhydride, glycidyl acrylate, glycidyl methacrylate, acrylic acid, methacrylic acid, vinyl acetate, C1-C12 alkyl acrylate, and C1-C12 alkyl methacrylate.

21. The polyamide moulding compound claim 16, wherein component (C) is selected from the group consisting of:
polyolefins (C1) of ethylene and glycidyl methacrylate;
polyolefins (C1) of ethylene, vinyl acetate, and glycidyl methacrylate;
polyolefins (C1) of ethylene, methyl acrylate, and glycidyl methacrylate;
polyolefins (C1) of ethylene, butyl acrylate, and glycidyl methacrylate;
block copolymers (C2) of 20 to 60 wt. % styrene, 40 to 80 wt. % ethylene and butylene, grafted with 0.5 to 4 wt. % maleic anhydride;
and a mixture of polyolefins (C1) and block copolymers (C2).

22. The polyamide moulding compound according to claim 16, wherein component (D) is selected from the group consisting of UV stabilizers, heat stabilizers, radical scavengers, antioxidants, processing aids, anti-blocking agents, lubricants, mould release agents, plasticizers, antistatic agents, fillers, flame retardants, dyes, pigments, residues from polymerization processes, and mixtures thereof.

23. The polyamide moulding compound claim 16, wherein
the proportion of component (A) is in the range of 48 to 83 wt;
and/or the proportion of component (B) is in the range of 9 to 32 wt. %;
and/or the proportion of component (C) is in the range of 8 to 17 wt;
and/or the proportion of component (D) is in the range of 0 to 3 wt. %.

24. A layer structure with at least one metal element and at least one polyamide layer formed from a polyamide moulding compound according to claim 16.

25. The layer structure according to claim 24, wherein the metal element consists of a metal selected from the group consisting of aluminium, copper, silver, zinc, iron, steel, mixtures thereof, and alloys thereof, wherein a surface is optionally oxidized and/or galvanized.

26. The layer structure according to claim 24, wherein the layer structure has one of the following structures:
metal element/polyamide layer; or
metal element/polyamide layer/further layer; or
metal element/further layer/polyamide layer; or
metal element/further layer/polyamide layer/further layer;
wherein said further layer is formed to an extent of at least 50 wt. % from a thermoplastic moulding compound which is different from the polyamide moulding compound.

27. The layer structure according to claim 24, wherein the metal element is a metal profile.

28. The layer structure according to claim 27, wherein the metal profile is a wire or flat conductor, which is optionally covered over its entire circumference by the polyamide layer without any further layer being arranged between the metal element and the polyamide layer.

29. The layer structure according claim 24, which is an electrical conductor in which the thickness of the polyamide layer, measured perpendicular to the main direction of the conductor, is in the range of 0.1-2 mm.

30. A method for producing a layer structure according to claim 24, wherein the metal element is coated with the polyamide layer in an extrusion process.
